(19) United States
(12) Patent Application Publication
(10) Pub. No.: US 2023/0049106 A1
(43) Pub. Date: Feb. 16, 2023

(54) METHOD PERFORMED BY USER EQUIPMENT, AND USER EQUIPMENT

(71) Applicant: Sharp Kabushiki Kaisha, Sakai City, Osaka (JP)

(72) Inventors: Yinan ZHAO, Shanghai (CN); Renmao LIU, Shanghai (CN); Chao LUO, Shanghai (CN)

(21) Appl. No.: 17/912,296

(22) PCT Filed: Mar. 24, 2021
(86) PCT No.: PCT/CN2021/082520

§ 371 Date: Sep. 16, 2022

(30) Foreign Application Priority Data
Mar. 25, 2020 (CN) 202010220897.4

(51) Int. Cl. H04L 5/00; H04W 72/04

(52) U.S. Cl. CPC H04L 5/0053; H04W 72/0406

(57) ABSTRACT

The present invention provides a method performed by user equipment, and user equipment. The method includes: determining sidelink resource pool configuration information; and determining the number Q′_{SCI2} of coded modulation symbols of second stage SCI. The second stage SCI is second stage sidelink control information carried by a physical sidelink shared channel (PSSCH).

### TECHNICAL FIELD

The present invention relates to the technical field of wireless communications, and in particular to a method performed by user equipment, and corresponding user equipment.

### BACKGROUND

In conventional cellular networks, all communication needs to be forwarded via base stations. By contrast, D2D communication (device-to-device communication) refers to a technique in which two user equipment units directly communicate with each other without needing a base station or a core network to perform forwarding therebetween. A research project on the use of LTE equipment to implement proximity D2D communication services was approved at the 3rd Generation Partnership Project (3GPP) RAN #63 plenary meeting in March 2014 (see Non-Patent Document 1). Functions introduced in the LTE Release 12 D2D include:

1) a discovery function between proximate devices in an LTE network coverage scenario;

2) a direct broadcast communication function between proximate devices; and

3) support for unicast and groupcast communication functions at higher layers.

A research project on enhanced LTE eD2D (enhanced D2D) was approved at the 3GPP RAN #66 plenary meeting in December 2014 (see Non-Patent Document 2). Main functions introduced in the LTE Release 13 eD2D include:

1) a D2D discovery in out-of-coverage and partial-coverage scenarios; and

2) a priority handling mechanism for D2D communication.

Based on the design of the D2D communication mechanism, a V2X feasibility research project based on D2D communication was approved at the 3GPP RAN #68 plenary meeting in June 2015. V2X stands for Vehicle to Everything, and intends to implement information exchange between a vehicle and all entities that may affect the vehicle, for the purpose of reducing accidents, alleviating traffic congestion, reducing environmental pollution, and providing other information services. Application scenarios of V2X mainly include four aspects:

1) V2V, Vehicle to Vehicle, i.e., vehicle-to-vehicle communication;

2) V2P, Vehicle to Pedestrian, i.e., a vehicle transmits alarms to a pedestrian or a non-motorized vehicle;

3) V2N: Vehicle-to-Network, i.e., a vehicle connects to a mobile network;

4) V2I: Vehicle-to-Infrastructure, i.e., a vehicle communicates with road infrastructure.

3GPP divides the research and standardization of V2X into three stages. The first stage was completed in September 2016, and was mainly focused on V2V and based on LTE Release 12 and Release 13 D2D (also known as sidelink communication), that is, the development of proximity communication technologies (see Non-Patent Document 3). V2X stage 1 introduced a new D2D communication interface referred to as PC5 interface. The PC5 interface is mainly intended to address the issue of cellular Internet of Vehicle (IoV) communication in high-speed (up to 250 km/h) and high-node density environments. Vehicles can exchange information such as position, speed, and direction through the PC5 interface, that is, the vehicles can communicate directly through the PC5 interface. Compared with the proximity communication between D2D devices, functions introduced in LTE Release 14 V2X mainly include:

1) higher density DMRS to support high-speed scenarios;

2) introduction of subchannels to enhance resource allocation methods; and

3) introduction of a user equipment sensing mechanism with semi-persistent scheduling.

The second stage of the V2X research project belonged to the LTE Release 15 research category (see Non-Patent Document 4). Main features introduced included high-order 64QAM modulation, V2X carrier aggregation, short TTI transmission, as well as feasibility study of transmit diversity.

The corresponding third stage, V2X feasibility research project based on 5G NR network technologies (see Non-Patent Document 5), was approved at the 3GPP RAN #80 plenary meeting in June 2018.

At the 3GPP RAN1 #98 meeting in August 2019 (see Non-Patent Document 6), the following meeting conclusions were reached regarding sidelink control information (SCI) in NR sidelink:
A 2-stage SCI transmission (2-stage SCI) is supported in NR sidelink.
   1^{st} stage SCI is transmitted by means of a sidelink control channel (PSCCH).

At the 3GPP RAN1 #98bis meeting in October 2019 (see Non-Patent Document 7), the following meeting conclusions were reached regarding second-stage SCI in NR sidelink:
2^{nd} stage SCI is transmitted in resources of a corresponding PSSCH.

The solutions of the present invention mainly include a method for determining, by NR sidelink user equipment, the number of coded modulation symbols for second stage SCI transmission.

### PRIOR ART DOCUMENT

### Non-Patent Documents

Non-Patent Document 1: RP-140518, Work item proposal on LTE Device to Device Proximity Services
Non-Patent Document 2: RP-142311, Work Item Proposal for Enhanced LTE Device to Device Proximity Services
Non-Patent Document 3: RP-152293, New WI proposal: Support for V2V services based on LTE sidelink
Non-Patent Document 4: RP-170798, New WID on 3GPP V2X Phase 2
Non-Patent Document 5: RP-181480, New SID Proposal: Study on NR V2X
Non-Patent Document 6: RAN1 #98, Chairman notes, section 7.2.4.1
Non-Patent Document 7: RAN1 #98bis, Chairman notes, section 7.2.4.1

### SUMMARY

In order to address at least part of the aforementioned issues, the present invention provides a method performed by user equipment, and user equipment.

The method performed by user equipment in a first aspect of the present invention comprises: determining sidelink resource pool configuration information; and determining the number Q′_{SCI2} of coded modulation symbols of second stage SCI. The second stage SCI is second stage sidelink control information carried by a physical sidelink shared channel (PSSCH).

In the method performed by user equipment according to the first aspect of the present invention, the number Q′_{SCI2} of coded modulation symbols of the second stage SCI is determined at least according to M_{SC}^{PSCCH}(l), wherein M_{SC}^{PSCCH}(l) is the number of subcarriers carrying a physical sidelink control channel (PSCCH) on OFDM symbol l.

User equipment in a second aspect of the present invention comprises: a processor; and a memory storing instructions, wherein the instructions, when run by the processor, perform the method performed by user equipment according to the first aspect.

### Effect of Invention

According to the present invention, a method performed by user equipment, and user equipment can be provided, which are effectively applicable to application scenarios of V2X based on 5G NR network technology.

### BRIEF DESCRIPTION OF THE DRAWINGS

The above and other features of the present invention will be more apparent from the following detailed description in combination with the accompanying drawings, in which:

FIG. 1 is a schematic diagram showing sidelink communication of LTE V2X UE.

FIG. 2 is a schematic diagram showing a resource allocation mode of LTE V2X.

FIG. 3 is a schematic diagram showing a basic procedure of a method performed by user equipment according to Embodiment 1 of the invention.

FIG. 4 is a schematic diagram showing a basic procedure of a method performed by user equipment according to Embodiment 2 of the invention.

FIG. 5 is a block diagram showing user equipment according to an embodiment of the present invention.

### DETAILED DESCRIPTION

The following describes the present invention in detail with reference to the accompanying drawings and specific embodiments. It should be noted that the present invention should not be limited to the specific embodiments described below. In addition, detailed descriptions of well-known technologies not directly related to the present invention are omitted for the sake of brevity, in order to avoid obscuring the understanding of the present invention.

In the following description, a 5G mobile communication system and its later evolved versions are used as exemplary application environments to set forth a plurality of embodiments according to the present invention in detail. However, it is to be noted that the present invention is not limited to the following implementations, but is applicable to many other wireless communication systems, such as a communication system after 5G and a 4G mobile communication system before 5G.

Some terms involved in the present invention are described below. Unless otherwise specified, the terms used in the present invention adopt the definitions herein.

The terms given in the present invention may vary in LTE, LTE-Advanced, LTE-Advanced Pro, NR, and subsequent communication systems, but unified terms are used in the present invention. When applied to a specific system, the terms may be replaced with terms used in the corresponding system.
3GPP: 3rd Generation Partnership Project
LTE: Long Term Evolution
NR: New Radio
PDCCH: Physical Downlink Control Channel
DCI: Downlink Control Information
PDSCH: Physical Downlink Shared Channel
UE: User Equipment
eNB: evolved NodeB, evolved base station
gNB: NR base station
TTI: Transmission Time Interval
OFDM: Orthogonal Frequency Division Multiplexing
CP-OFDM: Cyclic Prefix Orthogonal Frequency Division Multiplexing
C-RNTI: Cell Radio Network Temporary Identifier
CSI: Channel State Information
HARQ: Hybrid Automatic Repeat Request
CSI-RS: Channel State Information Reference signal
CRS: Cell Reference Signal
PUCCH: Physical Uplink Control Channel
PUSCH: Physical Uplink Shared Channel
UL-SCH: Uplink Shared Channel
CG: Configured Grant
Sidelink: Sidelink communication
SCI: Sidelink Control Information
PSCCH: Physical Sidelink Control Channel
MCS: Modulation and Coding Scheme
RB: Resource Block
RE: Resource Element
CRB: Common Resource Block
CP: Cyclic Prefix
PRB: Physical Resource Block
PSSCH: Physical Sidelink Shared Channel
FDM: Frequency Division Multiplexing
RRC: Radio Resource Control
RSRP: Reference Signal Receiving Power
SRS: Sounding Reference Signal
DMRS: Demodulation Reference Signal
CRC: Cyclic Redundancy Check
PSDCH: Physical Sidelink Discovery Channel
PSBCH: Physical Sidelink Broadcast Channel
SFI: Slot Format Indication
TDD: Time Division Duplexing
FDD: Frequency Division Duplexing
SIB1: System Information Block Type 1
SLSS: Sidelink Synchronization Signal
PSSS: Primary Sidelink Synchronization Signal
SSSS: Secondary Sidelink Synchronization Signal
PCI: Physical Cell ID
PSS: Primary Synchronization Signal
SSS: Secondary Synchronization Signal
BWP: Bandwidth Part
GNSS: Global Navigation Satellite System
SFN: System Frame Number (radio frame number)
DFN: Direct Frame Number
IE: Information Element
SSB: Synchronization Signal Block
EN-DC: EUTRA-NR Dual Connection
MCG: Master Cell Group
SCG: Secondary Cell Group
PCell: Primary Cell
SCell: Secondary Cell
PSFCH: Physical Sidelink Feedback Channel
SPS: Semi-Persistent Scheduling
TA: Timing Advance
PT-RS: Phase-Tracking Reference Signal
TB: Transport Block
CB: Code Block
QPSK: Quadrature Phase Shift Keying
16/64/256QAM: 16/64/256 Quadrature Amplitude Modulation
AGC: Automatic Gain Control

The following is a description of the prior art associated with the solution of the present invention. Unless otherwise specified, the same terms in the specific embodiments have the same meanings as in the prior art.

It is worth pointing out that the V2X and sidelink mentioned in the description of the present invention have the same meaning. The V2X herein can also mean sidelink; similarly, the sidelink herein can also mean V2X, and no specific distinction and limitation will be made in the following text.

The resource allocation mode of V2X (sidelink) communication and the transmission mode of V2X (sidelink) communication in the description of the present invention can be replaced equivalently. The resource allocation mode involved in the description can mean transmission mode, and the transmission mode involved can mean resource allocation mode.

The PSCCH in the description of the present invention is used to carry SCI. The PSSCH associated with or relevant to or corresponding to or scheduled by PSCCH involved in the description of the present invention has the same meaning, and all refer to an associated PSSCH or a corresponding PSSCH. Similarly, the SCI (including first stage SCI and second stage SCI) associated with or relevant to or corresponding to PSSCH involved in the description has the same meaning, and all refer to associated SCI or corresponding SCI. It is worth pointing out that the first stage SCI, referred to as 1st stage SCI or SCI format 0-1, is transmitted in the PSCCH; and the second stage SCI, referred to as 2nd stage SCI or SCI format 0-2, is transmitted in resources of the corresponding PSSCH.

In the description of the present invention, ┌a┐ represents rounding a up. For example, ┌3.5┐=4; min{a, b} represents calculating a relatively small value in a and b; Σₗ₌₀^{N-1}M(l) represents summation of M(0), M(1), . . . , M(N−1).

### Sidelink Communication Scenario

1) Out-of-coverage sidelink communication: Both pieces of UE performing sidelink communication are out of network coverage (for example, the UE cannot detect any cell that meets a “cell selection criterion” on a frequency at which sidelink communication needs to be performed, and that means the UE is out of network coverage).

2) In-coverage sidelink communication: Both of two UEs performing sidelink communication are in network coverage (for example, the UE detects at least one cell that meets a “cell selection criterion” on a frequency at which sidelink communication needs to be performed, and that means the UE is in network coverage).

3) Partial-coverage sidelink communication: One of two UEs performing sidelink communication is out of network coverage, and the other is in network coverage.

From the perspective of a UE side, the UE has only two scenarios, out-of-coverage and in-coverage. Partial-coverage is described from the perspective of sidelink communication.

### Basic Procedure of LTE V2X (Sidelink) Communication

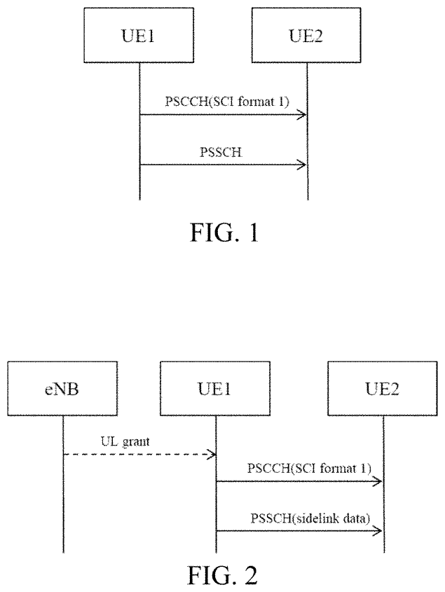

FIG. 1 is a schematic diagram showing sidelink communication of LTE V2X UE. First, UE1 transmits to UE2 sidelink control information (SCI format 1), which is carried by a physical layer channel PSCCH. SCI format 1 includes scheduling information of a PSSCH, such as frequency domain resources and the like of the PSSCH. Secondly, UE1 transmits to UE2 sidelink data, which is carried by the physical layer channel PSSCH. The PSCCH and the corresponding PSSCH are frequency division multiplexed, that is, the PSCCH and the corresponding PSSCH are located in the same subframe in the time domain but are located on different RBs in the frequency domain. Specific design methods of the PSCCH and the PSSCH are as follows:

1) The PSCCH occupies one subframe in the time domain and two consecutive RBs in the frequency domain. Initialization of a scrambling sequence uses a predefined value of 510. The PSCCH may carry SCI format 1, where SCI format 1 at least includes frequency domain resource information of the PSSCH. For example, for a frequency domain resource indication field, SCI format 1 indicates a starting subchannel number and the number of consecutive subchannels of the PSSCH corresponding to the PSCCH.

2) The PSSCH occupies one subframe in the time domain, and uses frequency division multiplexing (FDM) with the corresponding PSCCH. The PSSCH occupies one or a plurality of consecutive sub-channels in the frequency domain. The sub-channel represents n_{subCHsize} consecutive RBs in the frequency domain. n_{subCHsize} is configured by an RRC parameter, and a starting sub-channel and the number of consecutive sub-channels are indicated by the frequency domain resource indication field of SCI format 1.

### Resource Allocation Mode (Transmission Mode 3/4) of LTE V2X

FIG. 2 shows two resource allocation modes of LTE V2X, which are referred to as base station scheduling-based resource allocation (Transmission Mode 3) and UE sensing-based resource allocation (Transmission Mode 4), respectively. In LTE V2X, in eNB network coverage, a base station can configure, through UE-level dedicated RRC signaling SL-V2X-ConfigDedicated, a resource allocation mode of UE, or referred to as a transmission mode of the UE, which is specifically as follows:

1) Base station scheduling-based resource allocation mode (Transmission Mode 3): the base station scheduling-based resource allocation mode means that frequency domain resources used in sidelink communication are from scheduling of the base station. Transmission Mode 3 includes two scheduling modes, which are dynamic scheduling and semi-persistent scheduling (SPS), respectively. For dynamic scheduling, a UL grant (DCI format 5A) includes the frequency domain resources of the PSSCH, and a CRC of a PDCCH or an EPDCCH carrying the DCI format 5A is scrambled by an SL-V-RNTI. For SPS, the base station configures one or a plurality of (at most 8) configured grants through IE: SPS-ConfigSL-r14, and each configured grant includes a grant index and a resource period of the grant. The UL grant (DCI format 5A) includes the frequency domain resource of the PSSCH, indication information (3 bits) of the grant index, and indication information of SPS activation or release (or deactivation). The CRC of the PDCCH or the EPDCCH carrying the DCI format 5A is scrambled by an SL-SPS-V-RNTI.

Specifically, when RRC signaling SL-V2X-ConfigDedicated is set to scheduled-r14, it indicates that the UE is configured in a base station scheduling-based transmission mode. The base station configures the SL-V-RNTI or the SL-SPS-V-RNTI via RRC signaling, and transmits the UL grant to the UE through the PDCCH or the EPDCCH (DCI format 5A, the CRC is scrambled by the SL-V-RNTI or the SL-SPS-V-RNTI). The UL grant includes at least scheduling information of the PSSCH frequency domain resource in sidelink communication. When the UE successfully detects the PDCCH or the EPDCCH scrambled by the SL-V-RNTI or the SL-SPS-V-RNTI, the UE uses a PSSCH frequency domain resource indication field in the UL grant (DCI format 5A) as PSSCH frequency domain resource indication information in a PSCCH (SCI format 1), and transmits the PSCCH (SCI format 1) and a corresponding PSSCH.

For SPS in Transmission Mode 3, the UE receives, on a downlink subframe n, the DCI format 5A scrambled by the SL-SPS-V-RNTI. If the DCI format 5A includes the indication information of SPS activation, then the UE determines frequency domain resources of the PSSCH according to the indication information in the DCI format 5A, and determines time domain resources of the PSSCH (transmission subframes of the PSSCH) according to information such as the subframe n and the like.

2) UE sensing-based resource allocation mode (Transmission Mode 4): The UE sensing-based resource allocation mode means that resources used for sidelink communication are based on a procedure of sensing a candidate available resource set by the UE. When the RRC signaling SL-V2X-ConfigDedicated is set to ue-Selected-r14, it indicates that the UE is configured in the UE sensing-based transmission mode. In the UE sensing-based transmission mode, the base station configures an available transmission resource pool, and the UE determines a PSSCH sidelink transmission resource in the transmission resource pool according to a certain rule (for a detailed description of the procedure, see the LTE V2X UE sensing procedure section), and transmits a PSCCH (SCI format 1) and a corresponding PSSCH.

### Sidelink Resource Pool

In sidelink communication, resources transmitted and received by UEs all belong to resource pools. For example, for a base station scheduling-based transmission mode in sidelink communication, the base station schedules transmission resources for sidelink UE in the resource pool; alternatively, for a UE sensing-based transmission mode in sidelink communication, the UE determines a transmission resource in the resource pool.

### Numerologies in NR (Including NR Sidelink) and Slots in NR (Including NR Sidelink)

A numerology comprises two aspects: a subcarrier spacing and a cyclic prefix (CP) length. NR supports five subcarrier spacings, which are respectively 15 kHz, 30 kHz, 60 kHz, 120 kHz and 240 kHz (corresponding to μ=0, 1, 2, 3, 4). Table 4.2-1 shows the supported transmission numerologies specifically as follows:

TABLE 4.2-1
Subcarrier Spacings Supported by NR

| μ | Δf = 2^{μ} · 15 [kHz] | CP (cyclic prefix) |
|---|---|---|
| 0 | 15 | Normal |
| 1 | 30 | Normal |
| 2 | 60 | Normal, extended |
| 3 | 120 | Normal |
| 4 | 240 | Normal |

Only when μ=2, that is, in the case of a 60 kHz subcarrier spacing, an extended CP is supported, whereas only a normal CP is supported in the case of other subcarrier spacings. For a normal CP, each slot includes 14 OFDM symbols; for an extended CP, each slot includes 12 OFDM symbols. For μ=0, that is, a 15 kHz subcarrier spacing, one slot=1 ms; μ=1, namely, a 30 kHz subcarrier spacing, one slot=0.5 ms; μ=2, namely, a 60 kHz subcarrier spacing, one slot=0.25 ms, and so on.

### Parameter Sets in LTE (Including LTE V2X) and Slots in LTE (Including LTE V2X) and Subframes

The LTE only supports a 15 kHz subcarrier spacing. Both the extended CP and the normal CP are supported in the LTE. The subframe has a duration of 1 ms and includes two slots. Each slot has a duration of 0.5 ms.

For a normal CP, each subframe includes 14 OFDM symbols, and each slot in the subframe includes 7 OFDM symbols; for an extended CP, each subframe includes 12 OFDM symbols, and each slot in the subframe includes 6 OFDM symbols.

### Resource Block (RB) and Resource Element (RE)

The resource block (RB) is defined in the frequency domain as N_{SC}^{RB}=12 consecutive subcarriers. For example, for a 15 kHz subcarrier spacing, the RB is 180 kHz in the frequency domain. For a 15 kHz×2^{μ} subcarrier spacing, the resource element (RE) represents one subcarrier in the frequency domain and one OFDM symbol in the time domain.

DMRS Associated with PSSCH (or DMRS for PSSCH)

In demodulation and decoding of the PSSCH, an associated DMRS is used to performed channel estimation. For a DMRS associated with PSSCH in LTE V2X, the DMRS and the PSSCH are located on the same PRB in the frequency domain. Time domain resources of the DMRS are OFDM symbol 2 and OFDM symbol 5 of the first slot in a subframe where the PSSCH is located, and include OFDM symbol 1 and OFDM symbol 4 of the second slot in this subframe. For example, in LTE V2X, if the PSSCH occupies 8 consecutive PRBs in the frequency domain, the total number of REs occupied by the corresponding DMRS of the PSSCH is equal to 384 (12×4×8), that is, the total number of REs occupied by the corresponding DMRS on each PRB is equal to 48 (12×4).

In NR sidelink, the DMRS corresponding to the PSSCH is also applicable to demodulation and decoding of the PSSCH. In the description herein, on a certain OFDM symbol l occupied in PSSCH transmission (l=0, 1, 2 . . . , N_{symbol}^{PSSCH}−1, wherein N_{symbol}^{PSSCH} represents the number of OFDM symbols occupied in PSSCH transmission), the number of subcarriers occupied by the DMRS corresponding to the PSSCH is denoted as M_{SC}^{DMRS}(l), or the number of subcarriers carrying the DMRS corresponding to the PSSCH on OFDM symbol l is M_{SC}^{DMRS}(l).

### DMRS Configuration Type 1/DMRS Configuration Type 2

The meaning of DMRS configuration type 1 is that the distribution of 12 REs (numbered 0-11) of the DMRS within one RB is RE0, RE2, RE4, RE6, RE8, and RE10. The meaning of DMRS configuration type 2 is that the distribution of 12 REs (numbered 0-11) of the DMRS within one RB is RE0, RE1, RE6, and RE7.

### DMRS Pattern in Time Domain

The DMRS pattern in the time domain includes information such as the number of OFDM symbols occupied by the DMRS within one slot, and/or starting OFDM symbols. The DMRS pattern in the time domain may include other information than the above, and the present invention is not limited thereto.

### Channel State Information Reference Signal (CSI-RS)

In Rel-15NR, in order to better adapt to the change of a wireless channel, UE reports channel state information to a gNB by measuring the CSI-RS. Similarly, a sidelink channel state reference signal (sidelink CSI-RS) is introduced in NR sidelink for sidelink UE to measure a sidelink channel state. After the sidelink UE measures the sidelink channel state according to the received sidelink CSI-RS, the sidelink UE uses the PSSCH to carry channel state information (CSI) and performs sidelink CSI reporting.

In the description herein, on a certain OFDM symbol l occupied in PSSCH transmission (l=0, 1, 2 . . . , N_{symbol}^{PSSCH}−1, wherein N_{symbol}^{PSSCH} represents the number of OFDM symbols occupied in PSSCH transmission), the number of subcarriers occupied by the sidelink CSI-RS is denoted as M_{SC}^{CSI-RS}(l), or the number of subcarriers carrying the sidelink CSI-RS on OFDM symbol l is M_{SC}^{CSI-RS}(l).

### Phase-Tracking Reference Signal (PT-RS)

In Rel-15NR, the PT-RS is used to track phase fluctuations over the entire transmission period (e.g. one slot) on a high band. Since the PT-RS is designed to track phase noise, the PT-RS is dense in the time domain and sparse in the frequency domain. The PT-RS will only appear together with the DMRS and will be transmitted only if the network is configured with the PT-RS. Similarly, a sidelink PT-RS is introduced in NR sidelink. The user equipment performs phase tracking according to the received PT-RS on a high band, so as to improve the demodulation performance.

In the description herein, on a certain OFDM symbol l occupied in PSSCH transmission (l=0, 1, 2 . . . , N_{symbol}^{PSSCH}−1, wherein N_{symbol}^{PSSCH} represents the number of OFDM symbols occupied in PSSCH transmission), the number of subcarriers occupied by the sidelink PT-RS is denoted as M_{SC}^{PT-RS}(l), or the number of subcarriers carrying the sidelink PT-RS on OFDM symbol l is M_{SC}^{PT-RS}(l).

### Physical Sidelink Control Channel (PSCCH)

In NR sidelink, the PSCCH occupies 2 or 3 OFDM symbols in the time domain. Sidelink resource pool (pre)configuration information includes configuration information of the number of OFDM symbols occupied by the PSCCH in the time domain, that is, 2 or 3 OFDM symbols. The number of PRBs occupied by the PSCCH in the frequency domain is also configured by means of resource pool (pre)configuration information, and the number of PRBs occupied by the PSCCH must not exceed the number of PRBs of one subchannel and must be located in one subchannel.

In the description herein, on a certain OFDM symbol l occupied in PSSCH transmission (l=0, 1, 2 . . . , N_{symbol}^{PSSCH}−1, wherein N_{symbol}^{PSSCH} represents the number of OFDM symbols occupied in PSSCH transmission), the number of subcarriers occupied by the PSCCH is denoted as M_{SC}^{PSCCH}(l), or the number of subcarriers carrying the PSCCH on OFDM symbol l is M_{SC}^{PSCCH}(l).

### Channel Coding

The same channel coding process as Rel-15 NR is included in NR sidelink, that is, a certain number of redundant bits are additionally transmitted on the basis of transmitting effective information bits, so as to improve the reliability and robustness of transmission. For a transport block (TB), the TB is divided into one or more code blocks (CB) during channel coding. A CRC check bit is added to each CB, and then corresponding channel coding is performed. It is assumed that the number of bits after channel encoding is N and a modulation order of a modulation mode adopted by the N bits is m (indicating that one coded modulation symbol or modulation symbol includes m bits). Then, rate matching is performed on the N bits, and the obtained number of modulation symbols is represented as s. And then it is indicated that the number of resource elements (RE) occupied by the bits after rate matching is s during resource mapping. The total number of bits is equal to s*m, and s*m≤N. It is worth pointing out that for the modulation order m, when the modulation mode is QPSK, m=2, and when the modulation mode is 16QAM, 64QAM, and 256QAM, m is equal to 4, 6, and 8, respectively.

In the description herein, the modulation mode of the second stage SCI is QPSK, and the modulation order m is equal to 2.

Hereinafter, specific examples and embodiments related to the present invention are described in detail. In addition, as described above, the examples and embodiments described in the present disclosure are illustrative descriptions for facilitating understanding of the present invention, rather than limiting the present invention.

### Embodiment 1

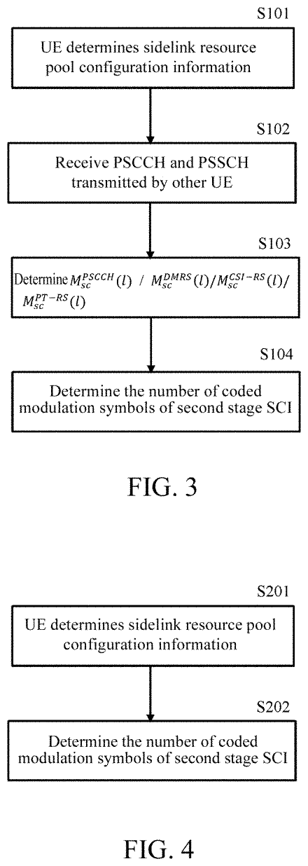

FIG. 3 is a schematic diagram showing a basic procedure of a method performed by user equipment according to Embodiment 1 of the present invention.

The method performed by user equipment according to Embodiment 1 of the present invention is described in detail below in conjunction with the basic procedure diagram shown in FIG. 3.

As shown in FIG. 3, in Embodiment 1 of the present invention, steps performed by the user equipment include the following steps.

In step S101, sidelink user equipment determines sidelink resource pool configuration information.

Optionally, the user equipment receives the sidelink resource pool configuration information transmitted by a base station.

Alternatively, optionally, the sidelink resource pool configuration information is included in pre-configuration information.

Optionally, the sidelink resource pool configuration information includes indication information α of a sidelink scaling factor.

In step S102, the sidelink user equipment receives a PSCCH and a corresponding PSSCH transmitted by other user equipment.

The PSCCH includes (or carries) first stage sidelink control information, that is, first stage SCI.

The PSSCH includes (or carries) second stage sidelink control information, that is, second stage SCI.

Optionally, the first stage SCI includes offset indication information β_{offset}^{SCI2} of the second stage SCI. The offset indication information is used to determine the number of coded modulation symbols of the second stage SCI.

In step S103, the sidelink user equipment determines M_{SC}^{PSCCH}(l), M_{SC}^{DMRS}(l), M_{SC}^{CSI-RS}(l), and M_{SC}^{PT-RS}(l).

Optionally, the sidelink user equipment determines M_{SC}^{PSCCH}(l) according to the sidelink resource pool configuration information.

Optionally, the sidelink user equipment determines M_{SC}^{SCI-RS}(l) according to the sidelink resource pool configuration information and/or the indication information included in the first stage SCI.

Optionally, the sidelink user equipment determines M_{SC}^{CSI-RS}(l) according to the sidelink resource pool configuration information and/or the indication information included in the first stage SCI (or the indication information included in the second stage SCI).

Optionally, the sidelink user equipment determines M_{SC}^{PT-RS}(l) according to the sidelink resource pool configuration information and/or the indication information included in the first stage SCI.

In step S104, the sidelink user equipment determines the number Q′_{SCI2} of coded modulation symbols of the second stage SCI according to α, and/or β_{offset}^{SCI2}, and/or M_{SC}^{PSCCH}(l), and/or M_{SC}^{DMRS}(l), and/or M_{SC}^{CSI-RS}(l), and/or M_{SC}^{PT-RS}(l)

Optionally,

$${Q}_{SCI 2}^{′} = min \{ ⌈ \frac{( {O}_{SCI 2} + {L}_{SCI 2} ) \cdot {β}_{offset}^{SCI 2} \cdot {Σ}_{l = 0}^{{N}_{symbol}^{PSSCH} - 1} {M}_{SC}^{SCI 2} ( l )}{{\sum }_{r = 0}^{{C}_{SL - SCH} - 1} {K}_{r}} ⌉ , ⌈ α \cdot {Σ}_{l = 0}^{{N}_{symbol}^{PSSCH} - 1} {M}_{SC}^{SCI 2} ( l ) ⌉ \} + γ ,$$

wherein O_{SCI2} represents the number of bits of the second stage SCI; L_{SCI2} represents the number of CRC check bits of the second stage SCI; C_{SL-SCH} represents the number of code blocks (CB) of a sidelink shared channel (SL-SCH) in the PSSCH transmission; and Kᵣ represents the number of bits of the r^{th} code block of the sidelink shared channel (SL-SCH) in the PSSCH transmission.

And optionally, M_{SC}^{SCI2}(l)=M_{SC}^{PSSCH}(l)−M_{SC}^{DMRS}(l)−M_{SC}^{CSI-RS}(l)−M_{SC}^{PT-RS}(l)−M_{SC}^{PSCCH}(l). Wherein l=0, 1, 2 . . . , N_{symbol}^{PSSCH}−1, or, l=0, 1, 2 . . . N_{symbol}^{PSSCH}. N_{symbol}^{PSSCH} represents the number of OFDM symbols excluding the AGC symbol in the PSSCH transmission. M_{SC}^{PSSCH}(l) represents the number of subcarriers occupied by a PSSCH on OFDM symbol l. Optionally, the AGC symbol is an OFDM symbol.

And optionally, γ represents the number of vacant REs in a resource block (RB) where the last coded symbol of the second stage SCI is located, or γ ensures that after mapping the second stage SCI, the RB where the last coded symbol of the second stage SCI is located includes no remaining REs, or, γ represents the number of vacant REs in an RB where the last coded symbol (corresponding to or indicated by)

$$min \{ ⌈ \frac{( {O}_{SCI 2} + {L}_{SCI 2} ) \cdot {β}_{offset}^{SCI 2} \cdot {Σ}_{l = 0}^{{N}_{symbol}^{PSSCH} - 1} {M}_{SC}^{SCI 2} ( l )}{{\sum }_{r = 0}^{{C}_{SL - SCH} - 1} {K}_{r}} ⌉ , ⌈ α \cdot {Σ}_{l = 0}^{{N}_{symbol}^{PSSCH} - 1} {M}_{SC}^{SCI 2} ( l ) ⌉ \}$$

is located, or, γ is a certain (optionally minimum) integer (or value) so that (or to ensure that) the RB where the last coded symbol of Q′_{SCI2} is located includes no remaining (or vacant) REs.

### Embodiment 2

FIG. 4 is a schematic diagram showing a basic procedure of a method performed by user equipment according to Embodiment 2 of the present invention.

The method performed by user equipment according to Embodiment 2 of the present invention is described in detail below in conjunction with the basic procedure diagram shown in FIG. 4.

As shown in FIG. 4, in Embodiment 2 of the present invention, steps performed by the user equipment include the following steps.

In step S201, sidelink user equipment determines sidelink resource pool configuration information.

Optionally, the user equipment receives the sidelink resource pool configuration information transmitted by a base station.

Alternatively,

optionally, the sidelink resource pool configuration information is included in pre-configuration information.

Optionally, the sidelink resource pool configuration information includes indication information a of a sidelink scaling factor.

In step S202, the sidelink user equipment determines the number Q′_{SCI2} of coded modulation symbols of second stage SCI.

Optionally,

$${Q}_{SCI 2}^{′} = min \{ ⌈ \frac{( {O}_{SCI 2} + {L}_{SCI 2} ) \cdot {β}_{offset}^{SCI 2} \cdot {Σ}_{l = 0}^{{N}_{symbol}^{PSSCH} - 1} {M}_{SC}^{SCI 2} ( l )}{{\sum }_{r = 0}^{{C}_{SL - SCH} - 1} {K}_{r}} ⌉ , ⌈ α \cdot {Σ}_{l = 0}^{{N}_{symbol}^{PSSCH} - 1} {M}_{SC}^{SCI 2} ( l ) ⌉ \} + γ .$$

Wherein O_{SCI2} represents the number of bits of the second stage SCI; L_{SCI2} represents the number of CRC check bits of the second stage SCI; C_{SL-SCH} represents the number of code blocks (CB) of a sidelink shared channel (SL-SCH) in the PSSCH transmission; and Kᵣ represents the number of bits of the r^{th} code block of the sidelink shared channel (SL-SCH) in the PSSCH transmission.

And optionally, β_{offset}^{SCI2} represents a second stage SCI Beta_offset indicator indicated in the first stage SCI.

And optionally, M_{SC}^{SCI2}(l)=M_{SC}^{PSSCH}(l)−M_{SC}^{DMRS}(l)−M_{SC}^{CSI-RS}(l)−M_{SC}^{PT-RS}(l)−M_{SC}^{PSCCH}(l). Wherein l=0, 1, 2 . . . , N_{symbol}^{PSSCH}−1, or, l=0, 1, 2 . . . , N_{symbol}^{PSSCH}. N_{symbol}^{PSSCH} represents the number of OFDM symbols excluding the AGC symbol in the PSSCH transmission. M_{SC}^{PSSCH}(l) represents the number of subcarriers occupied by a PSSCH on OFDM symbol l. Optionally, the AGC symbol is an OFDM symbol. M_{SC}^{DMRS}(l) represents the number of subcarriers carrying a DMRS on OFDM symbol l in PSSCH transmission. M_{SC}^{CSI-RS}(l) represents the number of subcarriers carrying a sidelink CSI-RS on OFDM symbol l in PSSCH transmission. M_{SC}^{PT-RS}(l) represents the number of subcarriers carrying a sidelink PT-RS on OFDM symbol l in PSSCH transmission. M_{SC}^{PSCCH}(l) represents the number of subcarriers carrying a PSCCH on OFDM symbol l in PSSCH transmission.

And optionally, γ represents the number of vacant REs in a resource block (RB) where the last coded symbol of the second stage SCI is located, or γ ensures that after mapping the second stage SCI, the RB where the last coded symbol of the second stage SCI is located includes no remaining REs, or, γ represents the number of vacant REs in an RB where the last coded symbol (corresponding to or indicated by)

$$min \{ ⌈ \frac{( {O}_{SCI 2} + {L}_{SCI 2} ) \cdot {β}_{offset}^{SCI 2} \cdot {Σ}_{l = 0}^{{N}_{symbol}^{PSSCH} - 1} {M}_{SC}^{SCI 2} ( l )}{{\sum }_{r = 0}^{{C}_{SL - SCH} - 1} {K}_{r}} ⌉ , ⌈ α \cdot {Σ}_{l = 0}^{{N}_{symbol}^{PSSCH} - 1} {M}_{SC}^{SCI 2} ( l ) ⌉ \}$$

is located, or, γ is a certain (optionally minimum) integer (or value) so that (or to ensure that) the RB where the last coded symbol of Q′_{SCI2} is located includes no remaining (or vacant) REs.

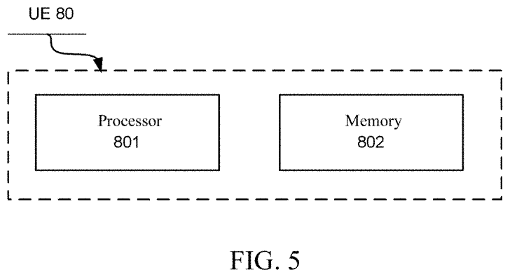

FIG. 5 is a block diagram showing user equipment (UE) involved in the present invention. As shown in FIG. 5, user equipment (UE) 80 includes a processor 801 and a memory 802. The processor 801 may include, for example, a microprocessor, a microcontroller, an embedded processor, and the like. The memory 802 may include, for example, a volatile memory (such as a random access memory (RAM)), a hard disk drive (HDD), a non-volatile memory (such as a flash memory), or other memories. The memory 802 stores program instructions. The instructions, when run by the processor 801, may perform the method performed by user equipment as described above in detail in the present invention.

The methods and related equipment according to the present invention have been described above in combination with preferred embodiments. It should be understood by those skilled in the art that the methods shown above are only exemplary, and the above embodiments can be combined with one another as long as no contradiction arises. The methods of the present invention are not limited to the steps or sequences illustrated above. The network node and user equipment illustrated above may include more modules. For example, the network node and user equipment may further include modules that can be developed or will be developed in the future to be applied to a base station, an MME, or UE, and the like. Various identifiers shown above are only exemplary, and are not meant for limiting the present invention. The present invention is not limited to specific information elements serving as examples of these identifiers. A person skilled in the art could make various alterations and modifications according to the teachings of the illustrated embodiments.

It should be understood that the above-described embodiments of the present invention may be implemented by software, hardware, or a combination of software and hardware. For example, various components inside the base station and the user equipment in the above embodiments may be implemented through various devices, which include, but are not limited to, analog circuit devices, digital circuit devices, digital signal processing (DSP) circuits, programmable processors, application specific integrated circuits (ASICs), field programmable gate arrays (FPGAs), programmable logic devices (CPLDs), and the like.

In this application, the “base station” may refer to a mobile communication data and control exchange center with large transmission power and a wide coverage area, including functions such as resource allocation and scheduling, data reception and transmission. “User equipment” may refer to a user mobile terminal, for example, including terminal devices that can communicate with a base station or a micro base station wirelessly, such as a mobile phone, a laptop computer, and the like.

In addition, the embodiments of the present invention disclosed herein may be implemented on a computer program product. More specifically, the computer program product is a product provided with a computer-readable medium having computer program logic encoded thereon. When executed on a computing device, the computer program logic provides related operations to implement the above technical solutions of the present invention. When executed on at least one processor of a computing system, the computer program logic causes the processor to perform the operations (methods) described in the embodiments of the present invention. Such setting of the present invention is typically provided as software, codes and/or other data structures provided or encoded on the computer readable medium, e.g., an optical medium (e.g., compact disc read-only memory (CD-ROM)), a flexible disk or a hard disk and the like, or other media such as firmware or micro codes on one or more read-only memory (ROM) or random access memory (RAM) or programmable read-only memory (PROM) chips, or a downloadable software image, a shared database and the like in one or more modules. Software or firmware or such configuration may be installed on a computing device such that one or more processors in the computing device perform the technical solutions described in the embodiments of the present invention.

In addition, each functional module or each feature of the base station device and the terminal device used in each of the above embodiments may be implemented or executed by a circuit, which is usually one or more integrated circuits. Circuits designed to execute various functions described in this description may include general-purpose processors, digital signal processors (DSPs), application specific integrated circuits (ASICs) or general-purpose integrated circuits, field programmable gate arrays (FPGAs) or other programmable logic devices, discrete gates or transistor logic, or discrete hardware components, or any combination of the above. The general purpose processor may be a microprocessor, or the processor may be an existing processor, a controller, a microcontroller, or a state machine. The aforementioned general purpose processor or each circuit may be configured by a digital circuit or may be configured by a logic circuit. Furthermore, when advanced technology capable of replacing current integrated circuits emerges due to advances in semiconductor technology, the present invention can also use integrated circuits obtained using this advanced technology.

While the present invention has been illustrated in combination with the preferred embodiments of the present invention, it will be understood by those skilled in the art that various modifications, substitutions, and alterations may be made to the present invention without departing from the spirit and scope of the present invention. Therefore, the present invention should not be limited by the above-described embodiments, but should be defined by the appended claims and their equivalents.

1. User equipment, comprising:
a processor; and
a memory storing instructions,
wherein the instructions stored in the memory are executable to:
determine a number of coded modulation symbols for second stage Sidelink Control Information (SCI) based on at least M_{sc}^{PSCCH}(l), wherein the M_{sc}^{PSCCH}(l) is the number of subcarriers in Orthogonal Frequency Division Multiplexing (OFDM) symbol that carry a Physical Sidelink Control Channel (PSCCH).

2. A method performed by user equipment, comprising:
determining a number of coded modulation symbols for second stage Sidelink Control Information (SCI) based on at least M_{sc}^{PSCCH}(l), wherein the M_{sc}^{PSCCH}(l) is the number of subcarriers in Orthogonal Frequency Division Multiplexing (OFDM) symbol that carry a Physical Sidelink Control Channel (PSCCH).

3. (canceled)
